(19) United States
(12) Patent Application Publication
(10) Pub. No.: US 2004/0009400 A1
(43) Pub. Date: Jan. 15, 2004

(54) Battery cathode active material, method for producing electrolytic manganese dioxide, and battery

(75) Inventors: Munetoshi Yamaguchi, Takehara-shi (JP); Yasuhiro Ochi, Takehara-shi (JP); Tsuyoshi Nagaishi, Takehara-shi (JP); Naoki Kumada, Takehara-shi (JP); Takeshi Asanuma, Takehara-shi (JP); Shigeo Hirayama, Takehara-shi (JP)

Correspondence Address: SUGHRUE MION, PLLC, 2100 Pennsylvania Avenue, NW, Washington, DC, 20037-3213, US

(73) Assignee: MITSUI MINING & SMELTING CO., LTD.

(21) Appl. No.: 10/436,461

(22) Filed: May 13, 2003

(30) Foreign Application Priority Data
May 15, 2002 (JP) 2002-140703

(51) Int. Cl. H01M 4/50; C25B 1/00

(52) U.S. Cl. 429/224; 205/57; 205/539

(57) ABSTRACT

The present invention provides a battery cathode active material formed of electrolytic manganese dioxide which has a large specific area and a high electric potential and can enhance battery characteristics such as high-rate characteristics and high-rate pulse characteristics when used as a battery cathode active material. The invention also provides a method for producing electrolytic manganese dioxide and a battery employing the cathode active material. The battery cathode active material is formed of electrolytic manganese dioxide containing a sulfate group in an amount of 1.3 to 1.6 wt. %.

### BACKGROUND OF THE INVENTION

1. Field of the Invention

The present invention relates to a battery cathode active material comprising electrolytic manganese dioxide, to a method for producing electrolytic manganese dioxide, and to a battery employing the cathode active material.

2. Background Art

Conventionally, manganese dioxide is known to be a typical battery cathode active material and is used in batteries such as a manganese battery and an alkaline manganese battery.

Known methods for producing such manganese dioxide for use as a battery cathode active material include a method comprising electrolysis of an electrolyte containing manganese sulfate and sulfuric acid. However, when the electrolytic manganese dioxide produced through the above method is employed as a cathode active material in a battery, performance of the battery is unsatisfactory, and therefore, various improvements have been proposed.

Specifically, Japanese Patent Application Laid-Open (kokai) No. 2-57693 discloses a method for producing electrolytic manganese dioxide including electrolysis of an electrolyte prepared by adding an aqueous phosphoric acid solution to a mixture of manganese sulfate and sulfuric acid. Through employment of the method, the yielded electrolytic manganese dioxide has a large specific surface area as compared with conventionally produced electrolytic manganese dioxide.

Efforts have also been made for elevating an electric potential of manganese dioxide by washing the manganese dioxide with a sulfuric acid solution.

Generally, manganese dioxide for use as a battery cathode active material desirably has a large reaction area and a high electric potential. In accordance with the trend for enhancing performance of batteries, manganese dioxide for use in batteries is required to have a larger specific surface area and higher electric potential as compared with conventional levels. In addition, manganese batteries, alkaline manganese batteries, and similar batteries are required to have improved high-rate characteristics (i.e., characteristics under high discharge current conditions) and high-rate pulse characteristics (i.e., characteristics under pulse-like repeated discharge conditions at high discharge current).

However, the aforementioned conventional electrolytic manganese dioxide products have a problem in that performance thereof remains unsatisfactory.

### SUMMARY OF THE INVENTION

In view of the foregoing, the present invention has been accomplished in order to solve the aforementioned problem. Thus, an object of the present invention is to provide a battery cathode active material comprising electrolytic manganese dioxide, the active material having a large specific surface area and a high electric potential, thereby enhancing high-rate characteristics, high-rate pulse characteristics, and similar characteristics upon use as a battery cathode active material. Another object of the present invention is to provide a method for producing electrolytic manganese dioxide. Still another object of the present invention is to provide a battery employing the cathode active material.

Accordingly, in a first embodiment of the present invention for solving the aforementioned problem, there is provided a battery cathode active material comprising electrolytic manganese dioxide, wherein the electrolytic manganese dioxide contains a sulfate group in an amount falling within a range of 1.3 to 1.6 wt. %.

Since the electrolytic manganese dioxide of the first embodiment contains a sulfate group, a high-performance battery cathode active material can be provided.

In a second embodiment of the present invention, the electrolytic manganese dioxide mentioned in relation to the first embodiment has a specific surface area falling within a range of 40 to 65 m²/g.

Since the electrolytic manganese dioxide of the second embodiment serving as a battery cathode active material has a specific surface area as large as 40 to 65 m²/g, battery performance can be enhanced when the electrolytic manganese dioxide is used in the battery.

In a third embodiment of the present invention, the electrolytic manganese dioxide mentioned in relation to the first or second embodiment has an electric potential falling within a range of 270 to 320 mV.

Since the electrolytic manganese dioxide of the third embodiment serving as a battery cathode active material has an electric potential as high as 270 to 320 mV, battery performance can be enhanced when the electrolytic manganese dioxide is used in the battery.

In a fourth embodiment of the present invention, the electrolytic manganese dioxide mentioned in relation to any one of the first to third embodiments is yielded by electrolyzing an electrolyte containing manganese sulfate and sulfuric acid at a temperature falling within a range of 85 to 95° C.; a current density falling within a range of 20 to 50 A/m²; and a sulfuric acid concentration falling within a range of 50 to 100 g/L.

When electrolysis is performed within the temperature, current density, and sulfuric acid concentration ranges mentioned in relation to the fourth embodiment, a battery cathode active material of high performance can be provided.

In a fifth embodiment of the present invention, there is provided a method for producing electrolytic manganese dioxide comprising electrolyzing an electrolyte containing manganese sulfate and sulfuric acid at a temperature falling within a range of 85 to 95° C.; a current density falling within a range of 20 to 50 A/m²; and a sulfuric acid concentration falling within a range of 50 to 100 g/L.

When electrolytic manganese dioxide is yielded through electrolysis performed within the temperature, current density, and sulfuric acid concentration ranges mentioned in relation to the fifth embodiment, a battery cathode active material of high performance can be provided.

In a sixth embodiment of the present invention, the electrolytic manganese dioxide mentioned in relation to the fifth embodiment contains a sulfate group in an amount falling within a range of 1.3 to 1.6 wt. %.

Since the electrolytic manganese dioxide of the sixth embodiment contains a sulfate group in an amount of 1.3 to 1.6 wt. %, a high-performance battery cathode active material can be provided.

In a seventh embodiment of the present invention, the electrolytic manganese dioxide mentioned in relation to the fifth or sixth embodiment has a specific surface area falling within a range of 40 to 65 m²/g.

Since the electrolytic manganese dioxide of the seventh embodiment has a specific surface area as large as 40 to 65 m²/g, battery performance can be enhanced when the electrolytic manganese dioxide is used in the battery.

In an eighth embodiment of the present invention, the electrolytic manganese dioxide mentioned in relation to any one of the fifth to seventh embodiments has an electric potential falling within a range of 270 to 320 mV.

Since the electrolytic manganese dioxide of the eighth embodiment has an electric potential as high as 270 to 320 mV, battery performance can be enhanced when the electrolytic manganese dioxide is used in the battery.

In a ninth embodiment of the present invention, there is provided a battery employing a battery cathode active material mentioned in relation to any one of the first to fourth embodiments.

Since the battery of the ninth embodiment employs a battery cathode active material formed of electrolytic manganese dioxide containing a sulfate group in an amount of 1.3 to 1.6 wt. %, a battery having excellent high-rate characteristics, high-rate pulse characteristics, and similar characteristics can be provided.

### BRIEF DESCRIPTION OF THE DRAWING

FIG. 1 shows a cross-section of an alkaline manganese battery according to the present invention.

### DETAILED DESCRIPTION OF PREFERRED EMBODIMENTS

The present invention will next be described in more detail.

The battery cathode active material according to the present invention is unique in that it comprises electrolytic manganese dioxide which is produced by electrolysis and contains a sulfate group (i.e., SO₄) incorporated into the manganese dioxide at the outset at which the manganese dioxide is produced through electrolysis. In other words, the sulfate group is not a species which is intentionally added to the battery cathode active material after electrolysis, but rather a species held by the chemical structure of the manganese dioxide. As used herein, the state in which “a sulfate group is contained in manganese dioxide” means a state in which removal of the contained sulfate group is not observed when, for example, the manganese dioxide is washed with an alkaline solution such as a sodium hydroxide solution. In this case, the sulfate group conceivably forms a uniform solid solution with manganese dioxide.

The electrolytic manganese dioxide of the present invention contains a sulfate group preferably in an amount of 1.3 to 1.6 wt. %. This is because when the sulfate group content is less than 1.3 wt. %, the effect on elevation of the electric potential of the electrolytic manganese dioxide is no longer prominent, whereas when the sulfate group content is in excess of 1.6 wt. %, the electric potential, which is generally elevated with increasing sulfate group content, rather decreases. Thus, when the electrolytic manganese dioxide contains a sulfate group in an amount of 1.3 to 1.6 wt. %, the electric potential is elevated to as high as 270 to 320 mV, thereby providing a battery cathode active material of high performance. Herein, in present invention, “electric potential” of the electrolytic manganese dioxide is a potential difference measured by using of mercury/mercury oxide electrode as a reference electrode, for example, in 10N KOH solution at 21±1° C.

Preferably, the electrolytic manganese dioxide of the present invention has a specific surface area of 40 to 65 m²/g. The specific surface area is measured through the BET one-point method, for example. An example of measurement condition is as followings;

Measurement equipment: Monosorb made by Quantachrome corporation

Sample weight: 0.15 g

Out gassing condition before measurement: 20 minutes in N₂ gas which flow rate is 30 cc/minutes at 250° C.

Absorption: form 21±1° C. to 77K

Desorption: form 77K to 21±1° C.

This is because when the specific surface area is less than 40 m²/g, the effect of the manganese dioxide serving as a battery cathode active material on enhancement in high-rate characteristics is no longer prominent, whereas when the specific surface area is more than 65 m²/g, fillability decreases, thereby deteriorating low-rate characteristics (i.e., characteristics under low discharge current conditions).

In order to cause a sulfate group to be contained in the electrolytic manganese dioxide, an electrolyte containing, for example, manganese sulfate and sulfuric acid is electrolyzed. Through the electrolysis, electrolytic manganese dioxide containing sulfate group which are held by the chemical structure of manganese dioxide can be obtained.

When the above electrolysis is performed under preferred conditions; i.e., temperature, current density, and sulfuric acid concentration, electrolytic manganese dioxide having a desired sulfate group content and specific surface area can be obtained.

Specifically, the temperature at electrolysis is preferably 85 to 95° C. This is because when the temperature is lower than 85° C., the specific surface area increases, thereby deteriorating low-rate characteristics of a battery employing the manganese dioxide serving as a battery cathode active material, whereas when the temperature is higher than 95° C., the specific surface area decreases, and the effect on enhancement in high-rate characteristics is no longer prominent. The current density at electrolysis is preferably 20 to 50 A/m². This is because when the current density is lower than 20 A/m², the specific surface area decreases, and the effect of the manganese dioxide serving as a battery cathode active material on enhancement in high-rate characteristics is no longer prominent, whereas when the current density is higher than 50 A/m², the amount of sulfate group contained in electrolytic manganese dioxide decreases, thereby lowering the electric potential, resulting in deterioration in battery characteristics. The sulfuric acid concentration in the electrolyte is preferably 50 to 100 g/L. This is because when the sulfuric acid concentration is lower than 50 g/L, the amount of sulfate group contained in electrolytic manganese dioxide decreases, thereby lowering the electric potential, resulting in deterioration in characteristics of batteries employing the manganese dioxide serving as a battery cathode active material, whereas when the sulfuric acid concentration is higher than 100 g/L, the amount of sulfate group contained in electrolytic manganese dioxide increases excessively, thereby lowering the electric potential, resulting in deterioration in battery characteristics.

Regarding other electrolysis conditions, there may be employed conditions adapted to conventional methods for producing electrolytic manganese dioxide comprising electrolyzing an electrolyte containing manganese sulfate and sulfuric acid. For example, the manganese concentration of the electrolyte is generally 20 to 50 g/L. The anode used in electrolysis may be formed of a material such as titanium, and the cathode used in electrolysis may be formed of a material such as carbon.

Since the thus-produced electrolytic manganese dioxide of the present invention contains a sulfate group in an amount of 1.3 to 1.6 wt. %, the electric potential is elevated to 270 to 320 mV. In addition, when the specific surface area is increased to 40 to 65 m²/g, a battery cathode active material of high performance can be provided.

The cathode active materials comprising the aforementioned electrolytic manganese dioxide can be suitably employed in batteries such as manganese batteries and alkaline manganese batteries.

No particular limitation is imposed on the anode active material of the battery of interest, and conventionally known materials may be used. When the battery is a manganese battery or an alkaline manganese battery, the anode active material comprising zinc or similar material is used.

No particular limitation is imposed on the electrolyte serving as a component of the battery, and conventionally known electrolytes may be used. When the battery is a manganese battery, zinc chloride or ammonium chloride is used, whereas when the battery is an alkaline manganese battery, potassium hydroxide or a similar electrolyte is used.

The electrolytic manganese dioxide according to the present invention, containing a sulfate group in an amount of 1.3 to 1.6 wt. %, has an electric potential as high as 270 to 320 mV. In addition, when the specific surface area is increased to 40 to 65 m²/g, high-rate characteristics and high-rate pulse characteristics of batteries employing the manganese dioxide serving as a battery cathode active material can be improved.

Thus, the electrolytic manganese dioxide preferably has a sulfate group content of 1.3 to 1.6 wt. % and a specific surface area of 40 to 65 m²/g. The conditions under which the electrolytic manganese dioxide is produced may be appropriately selected from the aforementioned ranges. Particularly when the temperature, current density, and sulfuric acid concentration fall within ranges of 85 to 95° C., 20 to 50 A/m², and 50 to 100 g/L, respectively, electrolytic manganese dioxide having a sulfate group content of 1.3 to 1.6 wt. % and a specific surface area of 40 to 65 m²/g can be produced without failure.

Accordingly, the method of the present invention for producing electrolytic manganese dioxide comprises performing electrolysis at a temperature of 85 to 95° C.; a current density of 20 to 50 A/m²; and a sulfuric acid concentration of 50 to 100 g/L.

When a cathode active material comprising electrolytic manganese dioxide having a sulfate group content of 1.3 to 1.6 wt. % and a specific surface area of 40 to 65 m²/g is used in an alkaline manganese battery, among other characteristics, high-rate pulse characteristics of the battery can be particularly enhanced by about 10 to 20%. The alkaline manganese battery having such excellent high-rate pulse characteristics can be suitably used in a digital camera or a similar device.

### EXAMPLES

The present invention will next be described in more detail by way of Examples and Comparative Examples, which should not be construed as limiting the invention thereto.

### Example 1

A 5-L beaker equipped with a heater was employed as an electrolysis vessel. A pipe for supplying an electrolyte comprising manganese sulfate was placed at the bottom of the electrolysis vessel. Titanium plates serving as anodes and graphite plates serving as cathodes were suspended inside the electrolysis vessel in such a manner that the anodes and cathodes were alternatingly juxtaposed. The electrolyte for supply was fed to the electrolysis vessel, while the composition of the electrolyte during electrolysis was adjusted to a manganese concentration of 40 g/L and a sulfuric acid concentration of 75 g/L. Electrolysis was performed for 20 days at a constant electrolyte temperature of 90° C. and a current density of 35 A/m².

After completion of electrolysis, anode plates on which manganese dioxide was electrodeposited were removed from vessel and subjected to a nomal post-treatment, to thereby yield electrolytic manganese dioxide of Example 1.

### Example 2

The procedure of Example 1 was repeated, except that the electrolyte temperature was adjusted to 85° C., to thereby yield electrolytic manganese dioxide of Example 2.

### Example 3

The procedure of Example 1 was repeated, except that the electrolyte temperature was adjusted to 95° C., to thereby yield electrolytic manganese dioxide of Example 3.

### Example 4

The procedure of Example 1 was repeated, except that the current density was adjusted to 20 A/m², to thereby yield electrolytic manganese dioxide of Example 4.

### Example 5

The procedure of Example 1 was repeated, except that the current density was adjusted to 50 A/m², to thereby yield electrolytic manganese dioxide of Example 5.

### Example 6

The procedure of Example 1 was repeated, except that the sulfuric acid concentration in the electrolyte was adjusted to 50 g/L, to thereby yield electrolytic manganese dioxide of Example 6.

### Example 7

The procedure of Example 1 was repeated, except that the sulfuric acid concentration in the electrolyte was adjusted to 100 g/L, to thereby yield electrolytic manganese dioxide of Example 7.

### Example 8

The procedure of Example 1 was repeated, except that the electrolyte temperature was adjusted to 80° C., to thereby yield electrolytic manganese dioxide of Example 8.

### Example 9

The procedure of Example 1 was repeated, except that the electrolyte temperature was adjusted to 98° C., to thereby yield electrolytic manganese dioxide of Example 9.

### Example 10

The procedure of Example 1 was repeated, except that the current density was adjusted to 15 A/m², to thereby yield electrolytic manganese dioxide of Example 10.

### Comparative Example 1

The procedure of Example 1 was repeated, except that the current density was adjusted to 55 A/m², to thereby yield electrolytic manganese dioxide of Comparative Example 1.

### Comparative Example 2

The procedure of Example 1 was repeated, except that the sulfuric acid concentration in the electrolyte was adjusted to 45 g/L, to thereby yield electrolytic manganese dioxide of Comparative Example 2.

### Comparative Example 3

The procedure of Example 1 was repeated, except that the sulfuric acid concentration in the electrolyte was adjusted to 105 g/L, to thereby yield electrolytic manganese dioxide of Comparative Example 3.

### Test Example 1

Sulfate group content, electric potential, and specific surface area of electrolytic manganese dioxide samples obtained in Examples 1 to 10 and Comparative Examples 1 to 3 were determined. The results are shown in Table 1. Notably, the sulfate group content of each electrolytic manganese dioxide sample was determined through routine ICP emission spectrochemical analysis. The electric potential was determined in the following manner. Briefly, each electrolytic manganese dioxide sample was secured to the inner surface of a nickel can by the application of pressure, and the sample was immersed in an aqueous potassium hydroxide solution for one day. The electric potential difference between the sample and a mercury/mercury oxide electrode was measured. The specific surface area was determined in the following manner. Each electrolytic manganese dioxide sample was heated at 250° C. for 20 minutes under nitrogen flow, to thereby remove water held in micropores. After removal of water, the specific surface area was measured through the BET one-point method.

TABLE 1

| | | | | Physical properties of | | |
|---|---|---|---|---|---|---|
| | | | | Electrolytic manganese | | |
| | Electrolysis Conditions | | | dioxide | | |
| | | | Sulfuric | | | Specific |
| | | Current | Acid | Sulfate | Electric | Surface |
| | Temperature | Density | Concentration | group | potential | area |
| | (° C.) | (A/m²) | (g/L) | (%) | (mV) | (m²/g) |
| Example 1 | 90 | 35 | 75 | 1.45 | 295 | 55 |
| Example 2 | 85 | 35 | 75 | 1.35 | 280 | 65 |
| Example 3 | 95 | 35 | 75 | 1.55 | 310 | 40 |
| Example 4 | 90 | 20 | 75 | 1.60 | 320 | 40 |
| Example 5 | 90 | 50 | 75 | 1.30 | 270 | 60 |
| Example 6 | 90 | 35 | 50 | 1.30 | 270 | 55 |
| Example 7 | 90 | 35 | 100 | 1.60 | 320 | 55 |
| Example 8 | 80 | 35 | 75 | 1.30 | 270 | 75 |
| Example 9 | 98 | 35 | 75 | 1.60 | 315 | 20 |
| Example 10 | 90 | 15 | 75 | 1.60 | 320 | 35 |
| Compara- | 90 | 55 | 75 | 1.25 | 265 | 65 |
| tive | | | | | | |
| Example 1 | | | | | | |
| Compara- | 90 | 35 | 45 | 1.25 | 265 | 55 |
| tive | | | | | | |
| Example 2 | | | | | | |
| Compara- | 90 | 35 | 105 | 1.65. | 250 | 55 |
| tive | | | | | | |
| Example 3 | | | | | | |

As is clear from Table 1, electrolytic manganese dioxide samples of Examples 1 to 10, having a sulfate group content of 1.3 to 1.6 wt. %, exhibit a high electric potential of 270 to 320 mV. Particularly, electrolytic manganese dioxide samples of Examples 1 to 7 have a specific surface area of 40 to 65 m²/g.

As is clear from the data obtained from Examples 1 to 7, electrolytic manganese dioxide having a sulfate group content of 1.3 to 1.6 wt. %, an electric potential of 270 to 320 mV, and a specific surface area of 40 to 65 m²/g can be obtained, when the manganese dioxide is produced through electrolysis performed at a temperature of 85 to 95° C., a current density of 20 to 50 A/m2 , and a sulfuric acid concentration of 50 to 100 g/L.

### Examples 1A to 10A

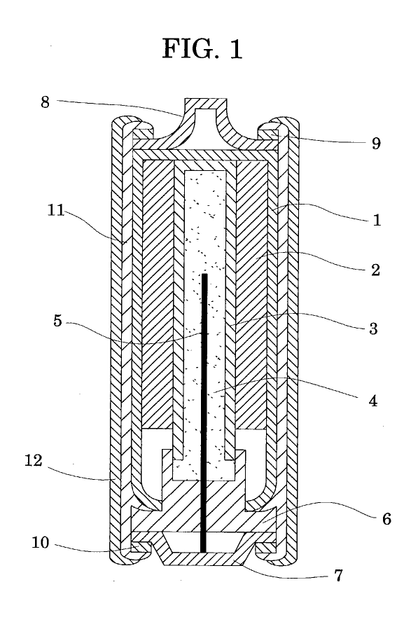

An alkaline manganese battery (LR6 size (AA size)) was fabricated from each of the electrolytic manganese dioxide samples of Examples 1 to 10 serving as a cathode active material. An electrolyte of the battery was prepared by adding zinc oxide to a 40% aqueous potassium hydroxide solution to the saturation concentration and adding, as gelling agents, carboxymethyl cellulose and sodium polyacrylate in amounts of about 1.0% to the zinc-oxide-saturated solution. Zinc powder (3.0 g) was employed as an anode active material, which was further mixed with the aforementioned electrolyte (1.5 g). The resultant mixture was gelled, and the gel, without undergoing any further treatment, was used as an anode material. FIG. 1 shows a longitudinal cross section of the thus-fabricated alkaline manganese battery.

As shown in FIG. 1, the alkaline manganese battery according to the present invention includes a cathode can 1 within which a cathode active material 2 comprising electrolytic manganese dioxide is disposed. An anode material 4 comprising zinc powder gel is disposed in the cathode active material 2 via a separator 3. An anode electricity collector 5 is inserted in the anode material 4. The anode electricity collector 5 penetrates a sealing member 6 which seals the bottom of the cathode can 1 so as to join to an anode bottom plate 7 provided under the sealing member 6. On the top of the cathode can 1, a cap 8 serving as a cathode terminal is provided. Insulating rings 9 and 10 are provided so as to crimp the cap 8 and the anode bottom plate 7 in a vertical direction. A heat-shrinkable resin tube 11 is provided so as to cover the periphery of the cathode can 1, and an outer can 12 is provided so as to cover the heat-shrinkable tube 11, whereby the cap 8 and the anode bottom plate 7 are secured via insulating rings 9 and 10.

### Comparative Examples 1A to 3A

In a manner similar to that employed in Examples 1A to 10A, an alkaline manganese battery was fabricated from each of electrolytic manganese dioxide samples of Comparative Examples 1 to 3 serving as a cathode active material.

### Test Example 2

The alkaline manganese batteries fabricated in Examples 1A to 10A and Comparative Examples 1A to 3A were discharged at 20° C. and a discharge current of 10 mA (low rate), and discharge time to reach a cut voltage (final voltage) of 0.9 V was determined. After the cut voltage measurement was normalized to the discharge time (an index of low-rate characteristics) of the battery of Example 9A, which was considered 100%, low-rate characteristics of the batteries were evaluated.

### Test Example 3

The alkaline manganese batteries fabricated in Examples 1A to 10A and Comparative Examples 1A to 3A were discharged at 20° C. and a discharge current of 1,000 mA (high rate), and discharge time to reach a cut voltage (final voltage) of 0.9 V was determined. After the cut voltage measurement was normalized to the discharge time (an index of high-rate characteristics) of the battery of Example 9A, which was considered 100%, high-rate characteristics of the batteries were evaluated.

### Test Example 4

The alkaline manganese batteries fabricated in Examples 1A to 10A and Comparative Examples 1A to 3A were discharged at 20° C. and a discharge current 1,000 mA (high rate) under repeated pulse conditions (10 seconds on and 50 seconds off), and the number of pulse repetitions to reach a cut voltage (final voltage) of 0.9 V was determined. After the cut voltage measurement was normalized to the number of pulse repetitions (an index of high-rate pulse characteristics) of the battery of Example 9A, which was considered 100%, high-rate pulse characteristics of the batteries were evaluated. Table 2 shows the results of Test Examples 2 to 4. Table 2 also lists the sulfate group content and specific surface area of each of the electrolytic manganese dioxide samples shown in Table 1.

TABLE 2

| | Characteristics of alkaline manganese batteries | | | | |
|---|---|---|---|---|---|
| | Physical properties | | | | |
| | of electrolytic | | | | |
| | manganese dioxide | | | | |
| | | Specific | | | High-rate |
| | | surface | Low-rate | High-rate | pulse |
| | Sulfate group | area | characteristic | characteristic | characteristic |
| | (%) | (m²/g) | (%) | (%) | (%) |
| Example 1A | 1.45 | 55 | 103 | 110 | 115 |
| Example 2A | 1.35 | 65 | 101 | 105 | 120 |
| Example 3A | 1.55 | 40 | 105 | 110 | 110 |
| Example 4A | 1.60 | 40 | 107 | 115 | 110 |
| Example 5A | 1.30 | 60 | 100 | 103 | 118 |
| Example 6A | 1.30 | 55 | 100 | 103 | 115 |
| Example 7A | 1.60 | 55 | 107 | 115 | 115 |
| Example 8A | 1.30 | 75 | 80 | 90 | 105 |
| Example 9A | 1.60 | 20 | 100 | 100 | 100 |
| Example 10A | 1.60 | 35 | 100 | 95 | 100 |
| Comparative | | | | | |
| Example 1A | 1.25 | 65 | 90 | 90 | 100 |
| Comparative | | | | | |
| Example 2A | 1.25 | 55 | 85 | 85 | 100 |
| Comparative | | | | | |
| Example 3A | 1.65 | 55 | 80 | 75 | 90 |

As is clear from Table 2, the batteries of Examples 1A to 10A employing a cathode active material comprising electrolytic manganese dioxide having a sulfate group content of 1.3 to 1.6 wt. % generally exhibit an excellent high-rate characteristic and high-rate pulse characteristic, as compared with the batteries of Comparative Examples 1A to 3A. Particularly, the batteries of Examples 1A to 7A employing a cathode active material comprising electrolytic manganese dioxide having a specific surface area of 40 to 65 m²/g exhibit an excellent high-rate characteristic and high-rate pulse characteristic, as compared with the batteries of Examples 8A to 10A falling outside the scope of specific surface area of 40 to 65 m²/g.

As is clear from Tables 1 and 2, the alkaline manganese batteries of Examples 1A to 3A containing manganese dioxide obtained by electrolysis at 85 to 95° C. exhibit a high-rate characteristic increased by 5 to 10% and a high-rate pulse characteristic increased by 10 to 20%, as compared with the battery of Example 9A containing manganese dioxide obtained by electrolysis at 98° C. The battery of Example 8A containing manganese dioxide obtained by electrolysis at 80° C. exhibits a considerably decreased low-rate characteristic as compared with the batteries of Examples 1A to 3A and 9A

The batteries of Examples 1A, 4A and 5A containing manganese dioxide obtained by electrolysis at a current density of 20 to 50 A/m2 exhibit a high-rate pulse characteristic increased by 10 to 18%, as compared with the battery of Example 10A containing manganese dioxide obtained by electrolysis at a current density of 15 A/m². The battery of Comparative Example 1A containing manganese dioxide obtained by electrolysis at a current density of 55 A/m² exhibits all determined battery characteristics equal or inferior to those of the batteries of Examples 1A, 4A, 5A, and 10A.

The batteries of Examples 1A, 6A and 7A containing manganese dioxide obtained by electrolysis at a sulfuric acid concentration of 50 to 100 g/L exhibit a high-rate pulse characteristic increased by 15%, as compared with the battery of Comparative Example 2A containing manganese dioxide obtained by electrolysis at a sulfuric acid concentration of 45 g/L. The battery of Comparative Example 3A containing manganese dioxide obtained by electrolysis at a sulfuric acid concentration of 105 g/L exhibits all determined battery characteristics inferior to those of the batteries of Examples 1A, 6A, and 7A and Comparative Example 2A.

Therefore, the results of Examples 1A to 7A indicate that, when an alkaline manganese battery contains a cathode active material comprising electrolytic manganese dioxide which has been produced through electrolysis at a temperature of 85 to 95° C., a current density of 20 to 50 A/m², and a sulfuric acid concentration of 50 to 100 g/L and which has a sulfate group content of 1.3 to 1.6 wt. %, an electric potential of 270 to 320 mV, and a specific surface area of 40 to 65 m²/g, excellent high-rate characteristics and high-rate pulse characteristics of the battery can be attained.

As described herein above, according to the present invention, electrolytic manganese dioxide contains a sulfate group in an amount of 1.3 to 1.6 wt. %, whereby a high-electric-potential battery cathode active material is provided. When the specific surface area of the electrolytic manganese dioxide is increased to 40 to 65 m²/g, a high-performance battery cathode active material can be provided. Electrolytic manganese dioxide having a sulfate group content of 1.3 to 1.6 wt. %, an electric potential of 270 to 320 mV, and a specific surface area of 40 to 65 m²/g can be obtained, when the manganese dioxide is produced through electrolysis performed at a temperature of 85 to 95° C., a current density of 20 to 50 A/m², and a sulfuric acid concentration of 50 to 100 g/L. Furthermore, by employing the electrolytic manganese dioxide as a battery cathode active material, a battery exhibiting excellent properties such as high-rate characteristics and high-rate pulse characteristics can be provided.

What is claimed is:

1. A battery cathode active material comprising electrolytic manganese dioxide, wherein the electrolytic manganese dioxide contains a sulfate group in an amount falling within a range of 1.3 to 1.6 wt. %.

2. A battery cathode active material according to claim 1, wherein the electrolytic manganese dioxide has a specific surface area falling within a range of 40 to 65 m²/g.

3. A battery cathode active material according to claim 1, wherein the electrolytic manganese dioxide has an electric potential falling within a range of 270 to 320 mV.

4. A battery cathode active material according to claim 1, wherein the electrolytic manganese dioxide is yielded by electrolyzing an electrolyte containing manganese sulfate and sulfuric acid at a temperature falling within a range of 85 to 95° C.; a current density falling within a range of 20 to 50 A/m²; and a sulfuric acid concentration falling within a range of 50 to 100 g/L.

5. A method for producing electrolytic manganese dioxide comprising electrolyzing an electrolyte containing manganese sulfate and sulfuric acid at a temperature falling within a range of 85 to 95° C.; a current density falling within a range of 20 to 50 A/m²; and a sulfuric acid concentration falling within a range of 50 to 100 g/L.

6. A method for producing electrolytic manganese dioxide according to claim 5, wherein the electrolytic manganese dioxide contains a sulfate group in an amount falling within a range of 1.3 to 1.6 wt. %.

7. A method for producing electrolytic manganese dioxide according to claim 5, wherein the electrolytic manganese dioxide has a specific surface area falling within a range of 40 to 65 m²/g.

8. A method for producing electrolytic manganese dioxide according to any one of claims 5 to 7, wherein the electrolytic manganese dioxide has an electric potential falling within a range of 270 to 320 mV.

9. A battery employing a battery cathode active material as recited in any one of claims 1 to 4.
